(19) United States
(12) Patent Application Publication
(10) Pub. No.: US 2025/0365029 A1
(43) Pub. Date: Nov. 27, 2025

(54) WIRELESS COMMUNICATION MODULE AND CONTROLLING METHOD THEREOF

(71) Applicant: SAMSUNG ELECTRONICS CO., LTD., Suwon-si (KR)

(72) Inventors: Jehwan SEO, Suwon-si (KR); Yongjin KANG, Suwon-si (KR); Namhoon KIM, Suwon-si (KR); Sanggi OH, Suwon-si (KR); Minkyu LEE, Suwon-si (KR); Hyungyong LEE, Suwon-si (KR)

(73) Assignee: SAMSUNG ELECTRONICS CO., LTD., Suwon-si (KR)

(21) Appl. No.: 19/294,734

(22) Filed: Aug. 8, 2025

Related U.S. Application Data
(63) Continuation of application No. PCT/KR2023/021595, filed on Dec. 26, 2023.

(30) Foreign Application Priority Data
Feb. 23, 2023 (KR) 10-2023-0024640

(51) Int. Cl. H04B 1/401; H04B 1/00; H04W 4/80

(52) U.S. Cl. CPC H04B 1/401; H04B 1/0053; H04W 4/80

(57) ABSTRACT

An electronic device may include at least one antenna configured to transmit or receive wireless communication signals of different communication types, and a processor configured to control the at least one antenna to transmit or receive the wireless communication signals of different communication types. The wireless communication signals may include at least one of a Wi-Fi signal, a Bluetooth signal, or a Zigbee signal.

### CROSS-REFERENCE TO RELATED APPLICATION

This application is a bypass continuation application of International Patent Application No. PCT/KR2023/021595, filed on Dec. 26, 2023, which claims priority to Korean Patent Application No. 10-2023-0024640, filed on Feb. 23, 2023, in the Korean Intellectual Property Office, the disclosures of which are incorporated herein by reference in their entireties.

### BACKGROUND

The disclosure relates to a wireless communication module and a method for controlling the same, and more particularly, to a wireless communication module performing wireless communication and a method for controlling the wireless communication module.

In general, a display device is an output device that visually displays image information received from an external source or stored therein to a user, and is used in various fields such as homes and businesses.

Recently, a display device may perform various wireless communications such as Wi-Fi communication, Bluetooth communication, and Zigbee communication.

In exiting technologies, to perform various wireless communications, separate chips for performing each communication were used. For example, a separate chip was used, such as a Wi-Fi and Bluetooth communication chip for Wi-Fi communication and Bluetooth communication, and a Zigbee communication chip for Zigbee communication.

Using a plurality of chips may decrease productivity and increase material costs. Even when a plurality of chips are simply integrated into a single chip, a design change is required due to the increased chip size, and interference may occur due to the proximity of each communication antenna.

### SUMMARY

An aspect of the disclosure provides a wireless communication module that may perform various wireless communications in a single communication module without changing a design and that minimize interference between each wireless communication, and a method for controlling the wireless communication module.

Technical objects that can be achieved by the disclosure are not limited to the above-mentioned objects, and other technical objects not mentioned will be clearly understood by one of ordinary skill in the art to which the disclosure belongs from the following description.

According to an aspect of the disclosure, an electronic device may include at least one antenna configured to transmit or receive wireless communication signals of different communication types, and a processor configured to control the at least one antenna to transmit or receive the wireless communication signals of different communication types. The wireless communication signals may include at least one of a Wi-Fi signal, a Bluetooth signal, or a Zigbee signal.

According to an aspect of the disclosure, a method for controlling an electronic device may include: determining an antenna, from among a plurality of antennas, to transmit or receive wireless communication signals of different communication types, wherein the wireless communication signals comprises at least one of a Wi-Fi signal, a Bluetooth signal, or a Zigbee signal; and controlling the wireless communication signals to be transmitted or received by the determined antenna.

### BRIEF DESCRIPTION OF THE DRAWINGS

FIG. 1 is a diagram illustrating an electronic device including a plurality of communication modules for wireless communication according to one or more embodiments.

FIG. 2 is a diagram illustrating a frequency band according to a wireless communication method according to one or more embodiments.

FIG. 3 is a diagram illustrating that signal interference occurs according to an overlap of bands according to one or more embodiments.

FIG. 4 is a control block diagram of an electronic device including a wireless communication module according to one or more embodiments.

FIG. 5 is a diagram illustrating a wireless communication module that may perform various wireless communications with a single control chip according to one or more embodiments.

FIG. 6 is a diagram illustrating a wireless communication connection with an external device according to one or more embodiments.

FIG. 7 is a diagram illustrating execution of a specific application in a display device according to one or more embodiments.

FIG. 8 is a diagram illustrating a connection state of wireless communication according to one or more embodiments.

FIG. 9 is a diagram illustrating that various wireless communications are performed around a display device according to one or more embodiments.

FIG. 10 is a flowchart illustrating a method for controlling a wireless communication module according to one or more embodiments.

### DETAILED DESCRIPTION

Various embodiments and the terms used therein are not intended to limit the technology disclosed herein to specific forms, and the disclosure should be understood to include various modifications, equivalents, and/or alternatives to the corresponding embodiments.

In addition, like reference numerals refer to like elements throughout the specification.

In addition, the terms used herein is for the purpose of describing particular embodiments only and is not intended to limit the disclosure. A singular form of a noun corresponding to an item may include one or more of the items unless clearly indicated otherwise in a related context. It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

In addition, it is to be understood that when a certain component is referred to as being “connected to,” or “coupled with,” another component, it means that the component may be connected to or coupled with the other component directly or indirectly via a third component.

In addition, although the terms “first”, “second”, etc. may be used to describe various components, the terms do not limit the corresponding components, but are used only for the purpose of distinguishing one component from another. For example, without departing from the technical spirit or essential features of the disclosure, a first element may be referred to as a second element, and a second element may be referred to as a first element. As used herein, the term “and/or” includes any and all combinations of one or more of the associated listed items.

Hereinafter, an operating principle and embodiments of the disclosure will now be described with reference to accompanying drawings.

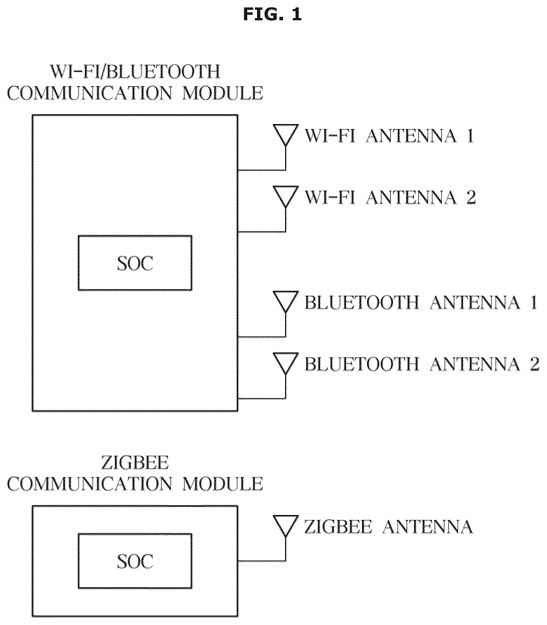

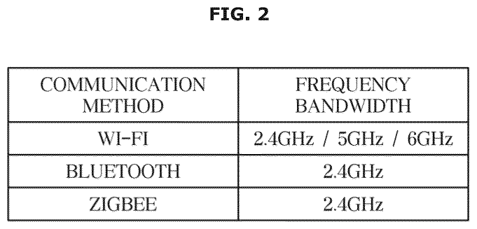

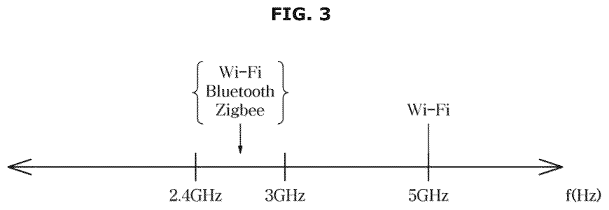

FIG. 1 is a diagram illustrating an electronic device including a plurality of communication modules for wireless communication according to one or more embodiments. FIG. 2 is a diagram illustrating a frequency band according to a wireless communication method according to one or more embodiments. FIG. 3 is a diagram illustrating that signal interference occurs according to an overlap of bands according to one or more embodiments.

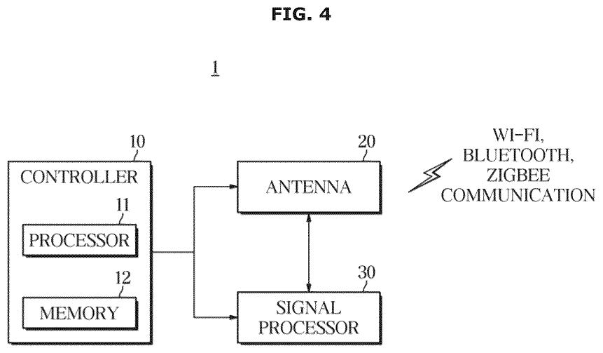

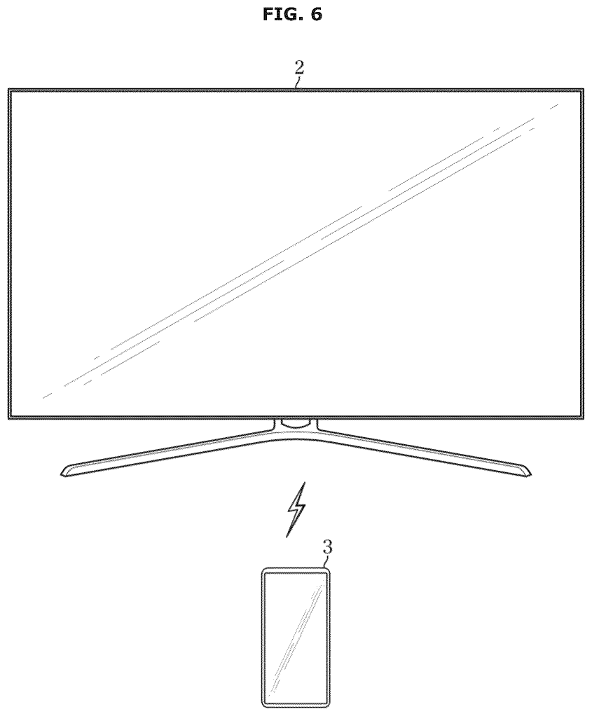

In the disclosure, as will be described below, a case where a display device 2 (see FIG. 6) performs wireless communication using a wireless communication module 1 (see FIG. 4) is described as an example. However, the disclosure is not limited to the display device 2, and may be applied to various electronic devices that may perform wireless communication.

A communication network may include both wired and wireless communication networks. The wired network may include a cable network using Ethernet (IEEE 802.3 technology standard), a telephone network, or the Internet. The wireless network may include a wireless network using Wi-Fi™ (IEEE 802.11 technology standard), Bluetooth™ (IEEE 802.15.1 technology standard), or ZigBee™ (IEEE 802.15.4 technology standard), Furthermore, the wireless network may include a mobile communication service network such as code division multiple access (CDMA), wideband code division multiple access (WCDMA), global system for mobile communications (GSM), long-term evolution (LTE), WiBro, and the like. The communication network NT is not limited thereto, and may include a communication network of a communication service to be implemented in the future.

Hereinafter, among the above wireless communications, Wi-Fi, Bluetooth, and Zigbee communications are mainly described as an example, but various wireless communication methods in addition to the above communication methods may be applicable.

Wi-Fi is a technology that allows electronic devices to connect to a wireless local area network (WLAN), and mainly uses the 2.4 GHz (12 centimeter) UHF and 5 GHz (6 centimeter) SHF ISM radio bands. Recently, by using an additional spectrum of 1200 MHz in the 6 GHz band, a new band that is not used by existing legacy devices is employed to reduce signal interference and collisions.

Bluetooth is a short-range wireless communication widely used to connect various devices. Bluetooth is implemented based on the same standard technology, thus ensuring good compatibility. Bluetooth uses a frequency-hopping method to communicate, specifically hopping among 79 channels 1,600 times per second to reduce the probability of signal overlap.

Bluetooth low energy (BLE) protocol is characterized by low power consumption and is mainly applied to devices where long-term use of a small battery is critical, such as smart watches and smart controls. BLE uses the 2.4 GHz band.

Zigbee is a standard technology for setting up personal communication networks and communicating using small, low-power digital radios, and is mainly used in fields that require long battery life and secure networking at low transmission rates. Zigbee uses the 2.4 GHz band.

In some embodiments, to perform each type of wireless communication such as Wi-Fi, Bluetooth, and Zigbee, separate modules may be used for each wireless communication.

For example, as shown in FIG. 1, a Wi-Fi/Bluetooth module for Wi-Fi and Bluetooth communication and a Zigbee module for Zigbee communication may be produced and used separately.

That is, each system-on-chip (SOC) integrated control chip included in each communication module may control a wireless communication antenna to perform wireless communication. However, using separate communication modules may reduce productivity and increase material costs, thereby decreasing competitiveness.

In a case where separate communication modules are simply combined and integrated into a single module, a plurality of SOC control chips are included in one module, causing an increase in size of the communication module and design change due to the size expansion.

In addition, as shown in FIG. 2, in the overlapping band (2.4 GHz) among the frequency bands used for Wi-Fi, Bluetooth, and Zigbee communications, signal interference caused by the overlap of the bands may weaken communication performance.

That is, as shown in FIG. 3, Wi-Fi, Bluetooth, and Zigbee communications are all available in the 2.4 GHz frequency band. Accordingly, in a case where the above wireless communications are performed simultaneously, communication performance weakens due to signal interference, and the like.

To address these challenges, the present disclosure provides one or more embodiments in which a single controller 10 (e.g., a single SOC control chip) may control Wi-Fi, Bluetooth, and Zigbee communications, and improve wireless communication performance by sharing an antenna 20, as described in detail below.

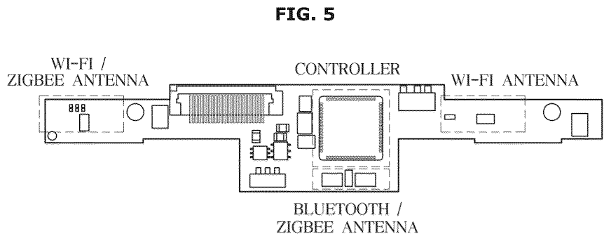

FIG. 4 is a control block diagram of an electronic device including a wireless communication module according to one or more embodiments. FIG. 5 is a diagram illustrating a wireless communication module that may perform various wireless communications with a single control chip according to one or more embodiments.

A wireless communication module 1 according to the disclosure may include at least one antenna 20, a signal processor 30, and the controller 10. The controller 10 may further include a processor 11 and a memory 12. The wireless communication module 1 may also be referred to as a wireless transceiver, which includes a radio frequency (RF) front end (e.g., amplifiers, mixers, filters), baseband circuitry (e.g., modulators, demodulators), and clocking circuitry. These components work together to enable the transmission and reception of wireless communication signals. While the signal processor 30 may be implemented as a dedicated digital signal processor (DSP) for RF or baseband processing, in some embodiments, it may be integrated into the processor 11.

The memory 12 may store programs and data for controlling the antenna 20 for wireless communication, and may temporarily store temporary data issued during wireless communication.

The memory 12 may store programs and data for controlling the wireless communication module 1, and may temporarily store temporary data that occurs while controlling the wireless communication module 1.

The memory 12 may include non-volatile memory such as read only memory (ROM) and flash memory for long-term data storage, and volatile memory such as static random access memory (S-RAM) and dynamic random access memory (D-RAM) for temporary data storage.

The at least one antenna 20 may transmit or receive wireless communication signals including at least one of a Wi-Fi signal, a Bluetooth signal, or a Zigbee signal. The at least one antenna 20 may include a shared antenna configured to transmit and receive multiple types of wireless communication signals (e.g., Wi-Fi, Bluetooth, or Zigbee). In some embodiments, the at least one antenna 20 may include multiple antennas, with at least one of them serving as a shared antenna capable of handling two or more types of wireless signals.

The signal processor 30 may encode or decode a signal transmitted or received by the at least one antenna 20.

The controller 10 may control the at least one antenna 20 and the signal processor 30 so that at least one of the Wi-Fi signal, the Bluetooth signal, or the Zigbee signal is transmitted or received by the at least one antenna 20.

That is, according the disclosure, all of the Wi-Fi, Bluetooth, and Zigbee communications may be performed in one wireless communication module 1.

To this end, the at least one antenna 20 may be designed in various ways.

As shown in FIG. 5, in a case where three antennas 20 are included, one antenna 20 may perform Wi-Fi and Zigbee communication, another antenna 20 may perform Bluetooth and Zigbee communication, and the remaining antenna 20 may perform Wi-Fi communication.

In this case, the antennas 20 may be designed separately for each frequency band of wireless communication.

In addition, the controller 10 may control the at least one antenna 20 to transmit or receive signals by band.

As the frequency bands are separated, signal interference due to overlapping frequency bands may be reduced, and wireless communication performance may be improved.

However, separating the antennas 20 by frequency band is only an example, and the antennas 20 may be designed in various other ways.

For example, all communications may be performed using only one antenna 20. In this case, a separate switch (e.g., an RF switch such as a PIN diode switch, a MEMS switch, or a solid-state RF switch) may be further included to select or switch between different frequency bands used for wireless communication.

In a case where the bandwidth of the signal transmitted or received by the at least one antenna 20 overlaps, the at least one antenna 20 may be controlled to operate in a time-division scheme.

For example, in a case where Bluetooth communication is performed using one antenna 20 and Zigbee communication, operating in an overlapping frequency band, is performed using another antenna 20, a time-division scheme may be applied. In this scheme, a Bluetooth signal may be turned on when a Zigbee signal being turned off, and the Zigbee signal may be turned on again when the Bluetooth signal is turned off. Accordingly, signal interference may be minimized.

In addition, a single antenna 20 may transmit or receive different wireless communication signals through time-division control.

In addition, as shown in FIG. 5, the at least one antenna 20 may be controlled by one controller 10 (e.g., a single SOC control chip). As a plurality of control chips included in existing plurality of communication modules are integrated into one integrated control chip, an increase in the size of the wireless communication module 1 may be prevented and design changes may be avoided.

As such, by performing various wireless communications in the wireless communication module 1 including a single control chip, design changes are not required, thereby improving productivity and competitiveness due to reduced cost. In addition, a wireless communication performance may be improved by minimizing signal interference.

Hereinafter, the controller 10 determining a wireless communication method and the antenna 20 to perform wireless communication is described.

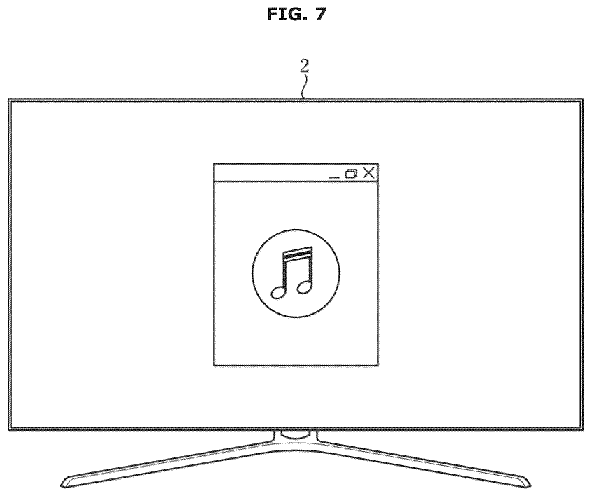

FIG. 6 is a diagram illustrating a wireless communication connection with an external device according to one or more embodiments. FIG. 7 is a diagram illustrating execution of a specific application in a display device according to one or more embodiments.

As described above, a case where the wireless communication module 1 included in the display device 2 performs wireless communication is described as an example.

In a case where wireless communication with an external device 3 such as a user terminal is performed, an antenna 20 to perform wireless communication may be determined according to a wireless communication method with the external device 3.

In a case where Bluetooth communication is performed between the external device 3 and the wireless communication module 1, the controller 10 may determine an antenna 20 for performing Bluetooth communication to perform Wi-Fi communication.

For example, referring to FIG. 5, it may be determined that the antenna 20 for performing Bluetooth communication among the three antennas 20 performs wireless communication.

In addition, Wi-Fi communication is often required when a specific application is executed on the display device 2. In this case, the controller 10 may determine the antenna 20 for performing Wi-Fi communication to perform Wi-Fi communication.

For example, referring to FIG. 5, in a case where the three antennas 20 are separated according to frequency bands, the antenna 20 to perform Wi-Fi communication may be determined according to the frequency band among the two antennas 20 that may perform Wi-Fi communication.

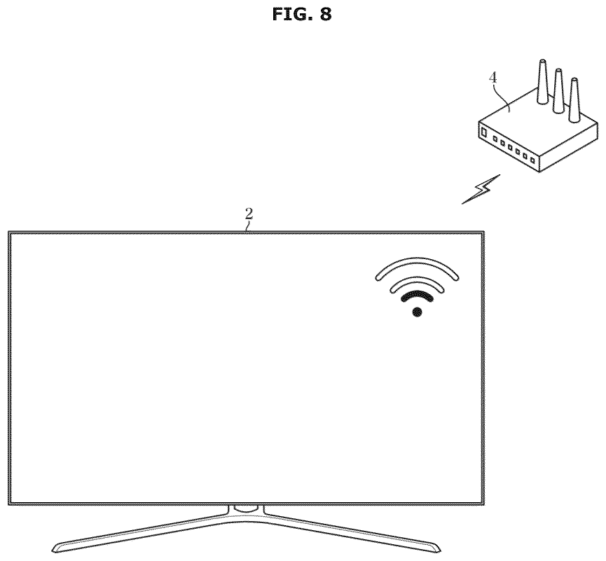

FIG. 8 is a diagram illustrating a connection state of wireless communication according to one or more embodiments.

The wireless communication module 1 may transmit and receive wireless signals to and from a wireless repeater 4 using various wireless communication standards. In addition, the wireless communication module 1 may receive a data stream from a content source via the wireless repeater 4.

For example, the wireless communication module 1 may connect to the wireless repeater 4 using a wireless communication standard such as Wi-Fi, Bluetooth, or Zigbee, and may receive a data stream from a content source via the wireless repeater 4.

In a case where the wireless communication module 1 transmits and receives a Wi-Fi signal with the wireless repeater 4, a performance of the Wi-Fi communication may temporarily decrease. In this case, sound interruption may occur. Accordingly, the wireless communication module 1 may allow communication other than Wi-Fi communication to be performed or allow wireless communication in a different frequency band to be performed.

The above is only an example of Wi-Fi communication, and may be equally applied even in cases where performance of other wireless communication methods decreases.

That is, the controller 10 may determine the antenna 20 to transmit or receive at least one of the Wi-Fi signal, the Bluetooth signal, or the Zigbee signal based on wireless communication performance. The wireless communication performance may refer to the effectiveness and quality of wireless data transmission and reception between devices. The wireless communication performance may include various metrics such as signal strength, data transfer rate, latency, packet loss, interference levels, and error rates. High wireless communication performance indicates strong, stable, and efficient communication, whereas low performance can result in issues like sound interruption, data loss, or connection dropouts. The controller 10 may continuously evaluate the wireless communication performance, such as when Wi-Fi signal quality drops (e.g., due to interference or weak signal strength), which may cause disruptions like sound interruption. When performance degradation is detected in one wireless communication type (e.g., Wi-Fi), the controller 10 may switch to another communication method (e.g., Bluetooth or Zigbee) or shift to a different frequency band (e.g., a different Wi-Fi frequency band) to maintain stable communication. Based on the measured performance of different wireless communication methods (e.g., Wi-Fi, Bluetooth, and Zigbee), the controller 10 may selects the antenna 20 for transmitting or receiving signals.

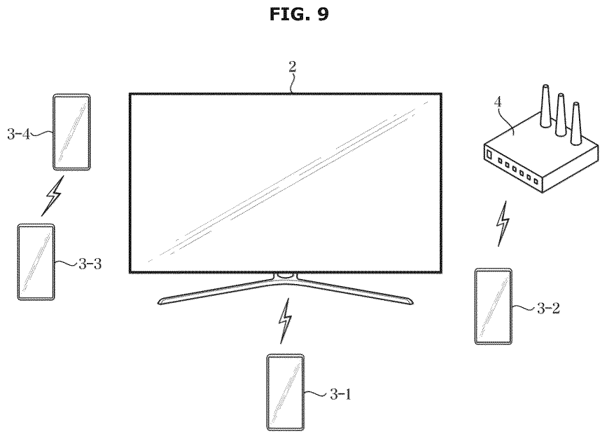

FIG. 9 is a diagram illustrating that various wireless communications are performed around a display device according to one or more embodiments.

In a case where the display device 2 and a first external device 3-1 perform wireless communication, communication between various external devices 3 may be performed in the vicinity.

For example, wireless communication may be performed between the wireless repeater 4 and a second external device 3-2, and Bluetooth communication may be performed between a third external device 3-3 and a fourth external device 3-4.

As such, in a case where other wireless communications are performed simultaneously in the vicinity while the wireless communication module 1 is performing communication, a decrease in wireless communication performance may occur due to interference of wireless communication signals.

The controller 10 may collect interference information of such surrounding wireless communication signals and allow appropriate wireless communication to be performed.

That is, the controller 10 may determine an antenna 20 to transmit or receive at least one of a Wi-Fi signal, a Bluetooth signal, or a Zigbee signal based on surrounding wireless communication interference information. The surrounding wireless communication interface information may refer to data about nearby wireless communication activities, including the types of wireless communication methods in use (e.g., Wi-Fi, Bluetooth, Zigbee), the active frequency bands, signal strengths, and interference levels. The surrounding wireless communication interface information may be collected from the environment surrounding the electronic device and used to assess potential interference or conflicts with the communication method of the electronic device.

For example, in a case where Bluetooth communication is being performed in the vicinity, the controller 10 may determine an antenna 20 to perform Wi-Fi communication in a different frequency band.

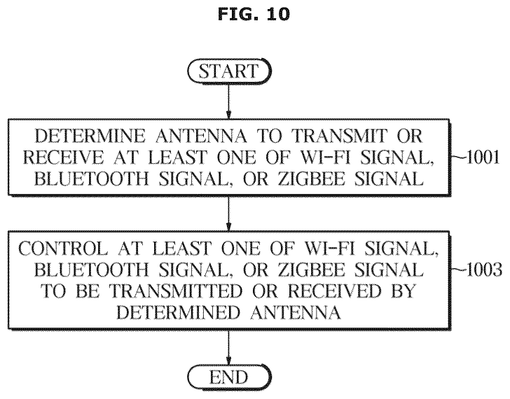

FIG. 10 is a flowchart illustrating a method for controlling a wireless communication module according to one or more embodiments.

The controller 10 may determine an antenna 20 to transmit or receive at least one of a Wi-Fi signal, a Bluetooth signal, or a Zigbee signal (operation 1001).

The antenna 20 may be determined in various ways, and may be determined based on a wireless communication connection state, wireless communication performance, surrounding wireless communication interference information, and the like.

In a case where wireless communication with an external device 3 such as a user terminal is performed, an antenna 20 to perform wireless communication may be determined according to a wireless communication method with the external device 3.

In a case where Bluetooth communication is performed between the external device 3 and the wireless communication module 1, the controller 10 may determine an antenna 20 for performing Bluetooth communication to perform Wi-Fi communication.

In addition, in a case where the wireless communication module 1 transmits and receives a Wi-Fi signal with the wireless repeater 4, a performance of the Wi-Fi communication may temporarily decrease. In this case, sound interruption may occur. Accordingly, the wireless communication module 1 may allow communication other than Wi-Fi communication to be performed or allow wireless communication in a different frequency band to be performed.

In a case where other wireless communications are performed simultaneously in the vicinity while the wireless communication module 1 is performing communication, a decrease in wireless communication performance may occur due to interference of wireless communication signals. The controller 10 may collect interference information of such surrounding wireless communication signals and allow appropriate wireless communication to be performed.

Thereafter, the controller 10 may control the determined antenna 20 to transmit or receive at least one of the Wi-Fi signal, the Bluetooth signal, or the Zigbee signal (operation 1003).

According to one or more embodiments of the disclosure, a wireless communication module may include: at least one antenna configured to transmit or receive at least one of a Wi-Fi signal, a Bluetooth signal, or a Zigbee signal; a signal processor configured to encode or decode a signal transmitted or received by the at least one antenna; and a controller configured to control the at least one antenna and the signal processor to allow the at least one of the Wi-Fi signal, the Bluetooth signal, or the Zigbee signal to be transmitted or received by the at least one antenna.

According to the disclosure, various wireless communications may be performed in a single communication module without changing a design, thereby increasing productivity and decreasing material costs.

The controller may be configured to control the at least one antenna to transmit or receive a signal by band.

The controller may be configured to control the at least one antenna to operate in a time-division scheme, based on presence of overlapping bandwidths of signals transmitted or received by the at least one antenna.

According to the disclosure, a wireless communication performance may be improved by minimizing interference between each wireless communication.

The controller may be configured to determine an antenna to transmit or receive the at least one of the Wi-Fi signal, the Bluetooth signal, or the Zigbee signal based on wireless communication connection information with an external device.

The controller may be configured to determine an antenna to transmit or receive the at least one of the Wi-Fi signal, the Bluetooth signal, or the Zigbee signal based on wireless communication performance.

The controller may be configured to determine an antenna to transmit or receive the at least one of the Wi-Fi signal, the Bluetooth signal, or the Zigbee signal based on surrounding wireless communication interference information.

According to the disclosure, a wireless communication performance may be improved by appropriately selecting an antenna to perform wireless communication and sharing the antenna.

According to one or more embodiments of the disclosure, in a method for controlling a wireless communication module including at least one antenna configured to transmit or receive at least one of a Wi-Fi signal, a Bluetooth signal, or a Zigbee signal, and a signal processor configured to encode or decode a signal transmitted or received by the at least one antenna, the method may include: determining an antenna to transmit or receive the at least one of the Wi-Fi signal, the Bluetooth signal, or the Zigbee signal; and controlling the at least one of the Wi-Fi signal, the Bluetooth signal, or the Zigbee signal to be transmitted or received by the determined antenna.

The method may further include controlling the at least one antenna to transmit or receive a signal by band.

The method may further include controlling the at least one antenna to operate in a time-division scheme, based on presence of overlapping bandwidths of signals transmitted or received by the at least one antenna.

The determining of the antenna to transmit or receive the signal may include determining the antenna to transmit or receive the at least one of the Wi-Fi signal, the Bluetooth signal, or the Zigbee signal based on wireless communication connection information with an external device.

The determining of the antenna to transmit or receive the signal may include determining the antenna to transmit or receive the at least one of the Wi-Fi signal, the Bluetooth signal, or the Zigbee signal based on wireless communication performance.

The determining of the antenna to transmit or receive the signal may include determining the antenna to transmit or receive the at least one of the Wi-Fi signal, the Bluetooth signal, or the Zigbee signal based on surrounding wireless communication interference information.

According to the disclosure, various wireless communications may be performed in a single communication module without changing a design, thereby increasing productivity and decreasing material costs, and a wireless communication performance may be improved by minimizing interference between each wireless communication.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that may be interpreted by a computer. For example, the computer-readable recording medium may be a read only memory (ROM), a random access memory (RAM), a magnetic tape, a magnetic disk, a flash memory, an optical data storage device, etc.

Although embodiments of the disclosure have been described with reference to the accompanying drawings, a person having ordinary skilled in the art will appreciate that other specific modifications may be easily made without departing from the technical spirit or essential features of the disclosure. Accordingly, the foregoing embodiments should be regarded as illustrative rather than limiting in all aspects.

What is claimed is:

1. An electronic device comprising:
at least one antenna configured to transmit or receive wireless communication signals of different communication types, wherein the wireless communication signals comprises at least one of a Wi-Fi signal, a Bluetooth signal, or a Zigbee signal; and
a processor configured to control the at least one antenna to transmit or receive the wireless communication signals of the different communication types.

2. The electronic device of claim 1, wherein the processor is configured to control the at least one antenna to transmit or receive the wireless communication signals based on respective frequency bands of the wireless communication signals.

3. The electronic device of claim 1, wherein the processor is configured to control the at least one antenna to operate in a time-division scheme, based on presence of overlapping bandwidths of the wireless communication signals that are transmitted or received by the at least one antenna.

4. The electronic device of claim 1, wherein the at least one antenna comprises a plurality of antennas, and wherein the processor is configured to determine an antenna, from among the plurality of antennas, to transmit or receive the at least one of the Wi-Fi signal, the Bluetooth signal, or the Zigbee signal based on wireless communication connection method for connecting the electronic device to an external device.

5. The electronic device of claim 1, wherein the at least one antenna comprises a plurality of antenna, and wherein the processor is configured to determine an antenna, from among the plurality of antennas, to transmit or receive the at least one of the Wi-Fi signal, the Bluetooth signal, or the Zigbee signal based on wireless communication performance.

6. The electronic device of claim 1, wherein the at least one antenna comprises a plurality of antenna, and wherein the processor is configured to determine an antenna, from among the plurality of antennas, to transmit or receive the at least one of the Wi-Fi signal, the Bluetooth signal, or the Zigbee signal based on surrounding wireless communication interference information.

7. A method for controlling an electronic device, the method comprising:
determining an antenna, from among a plurality of antennas, to transmit or receive wireless communication signals of different communication types, wherein the wireless communication signals comprises at least one of a Wi-Fi signal, a Bluetooth signal, or a Zigbee signal; and
controlling the wireless communication signals to be transmitted or received by the determined antenna.

8. The method of claim 7, further comprising:
controlling the determined antenna to transmit or receive the wireless communication signals based on respective frequency bands of the wireless communication signals.

9. The method of claim 7, further comprising:
controlling the determined antenna to operate in a time-division scheme, based on presence of overlapping bandwidths of the wireless communication signals that are transmitted or received by the at least one antenna.

10. The method of claim 7, wherein the determining of the antenna comprises determining the antenna to transmit or receive the at least one of the Wi-Fi signal, the Bluetooth signal, or the Zigbee signal based on wireless communication connection method for connecting the electronic device to an external device.

11. The method of claim 7, wherein the determining of the antenna comprises determining the antenna to transmit or receive the at least one of the Wi-Fi signal, the Bluetooth signal, or the Zigbee signal based on wireless communication performance.

12. The method of claim 7, wherein the determining of the antenna comprises determining the antenna to transmit or receive the at least one of the Wi-Fi signal, the Bluetooth signal, or the Zigbee signal based on surrounding wireless communication interference information.
